(19) United States
(12) Patent Application Publication
(10) Pub. No.: US 2023/0340203 A1
(43) Pub. Date: Oct. 26, 2023

(54) POLYMERS, COMPOSITIONS AND METHOD FOR MANUFACTURING AN ARTICLE BY 3D PRINTING

(71) Applicants: SOLVAY SPECIALTY POLYMERS USA, LLC, Alpharetta, GA (US); VIRGINIA TECH INTELLECTUAL PROPERTIES, INC., Blacksburg, VA (US)

(72) Inventors: Eduardo Soriano, Atlanta, GA (US); Joel Pollino, Johns Creek, GA (US); Kermit S. Kwan, Cumming, GA (US); Clay Bradley Arrington, Gilbert, AZ (US); Viswanath Meenakshisundaram, Blacksburg, VA (US); Timothy Edward Long, Blacksburg, VA (US); Christopher Bryant Williams, Blacksburg, VA (US); Daniel Andrew Rau, Blacksburg, VA (US)

(73) Assignees: SOLVAY SPECIALTY POLYMERS USA, LLC, Alpharetta, GA (US); VIRGINIA TECH INTELLECTUAL PROPERTIES, INC., Blacksburg, VA (US)

(21) Appl. No.: 17/998,774

(22) PCT Filed: May 12, 2021
(86) PCT No.: PCT/EP2021/062684

§ 371 Date: Nov. 14, 2022

Related U.S. Application Data
(60) Provisional application No. 63/025,142, filed on May 14, 2020.

(30) Foreign Application Priority Data
Jul. 14, 2020 (EP) 20185789.3

(51) Int. Cl. C08G 73/14; C08G 73/10; B29C 64/129

(52) U.S. Cl. CPC C08G 73/14; C08G 73/1025; C08G 73/1071; B29C 64/129; B29K 2079/085

(57) ABSTRACT

The present invention relates to poly(amide imide) (PAI) precursor polymers which can for example be used in Vat photopolymerization processes like lithographic processes for the photofabrication of three-dimensional (3D) articles. The invention further relates to polymer compositions including these poly(amide imide) (PAI) precursor polymers. Still further, the invention relates to vat photopolymerization methods to form three-dimensional (3D) objects that incorporate the aforementioned polymer compositions.

### RELATED APPLICATIONS

This application claims priorities of one patent application filed on May 14, 2020 in the UNITED STATES with No. 63/025,142 and one patent application filed on Jul. 14, 2020 in EUROPE with number 20185789.3, the whole content of these applications being incorporated herein by reference for all purposes.

### TECHNICAL FIELD

The present invention relates to poly(amide imide) (PAI) precursor polymers which can for example be used in Vat photopolymerization and lithographic processes for the photofabrication of three-dimensional (3D) articles. The invention further relates to polymer compositions including these poly(amide imide) (PAI) precursor polymers. Still further, the invention relates to Vat photopolymerization methods such as lithographic methods to form three-dimensional (3D) objects that incorporate the aforementioned polymer compositions.

### BACKGROUND

Polymer compositions are commonly used to manufacture articles for the automotive and aerospace industries, for example as engine parts, as well as in the healthcare industry, for example as implantable devices and dental prostheses. These articles have to present good mechanical properties after fabrication, but they also have to retain a sufficient percentage of these properties over time, notably at their temperature of use (sometimes as high as 150° C.). Notably, poly(amide imide) (PAI) polymers present a combination of mechanical strength and stability, enabling versatility in demanding aerospace and automotive environments. Additionally, low dielectric and coefficients of thermal expansion permit broad impact of these polymers in the microelectronics industry.

Vat photopolymerization processes such as lithographic processes for the photofabrication of 3D articles from polymeric materials have found recent popularity due to their relative speed and simplicity. In general, vat-photopolymerization processes such as lithographic processes involve the use of light, for example UV irradiation, to locally cure a polymerizable composition at specific locations. The localized curing allows for the fabrication of 3-dimensional articles. Vat photopolymerization (VP) or UV-assisted direct ink write printing (DIW) are two examples of light-based lithographic additive manufacturing techniques which afford high part resolution.

Lithographic processes generally use polymerizable compositions that are liquid in order to obtain parts with a good resolution. Polymerizable compositions that are liquid are room temperature are easier to use in a printing process, but they generally lead to articles having moderate mechanical properties and thermal stability.

WO18035368A1 relates to a polymer resin for vat photopolymerization. The polymer resin can include a polyamic diacrylate ester or salt thereof, the polyamic diacrylate ester or salt comprising a plurality of photocrosslinkable groups pendantly attached thereto; a photoinitiator suitable for initiating crosslinking of the photocrosslinkable groups when exposed to a light source of a suitable wavelength and intensity; and a suitable organic solvent.

Hegde, et al. “3D printing all-aromatic high-performance polyimides using pSLA: Processing the non-processable” (252nd ACS National Meeting & Exposition, Aug. 21-25, 2016) and Hegde et al. “3D Printing All-Aromatic Polyimides using Mask-Projection Stereolithography: Processing the Nonprocessable” (Adv. Mater. 2017, 29, published on Jun. 19, 2017), disclose 3D printing of a polyamic diacrylate ester (PADE) in which each repeating unit derives from 4,4′-oxydianiline (ODA) and pyromellitic dianhydride, and contains two photo-crosslinkable acrylate groups.

Herzberger et al. “3D Printing All-Aromatic Polyimides Using Stereolithographic 3D Printing of Polyamic Acid Salts” (ACS Macro Lett., 2018, 7 (4), pp 493-497) describes 3D printing of polyamic acid (PAA) structures derived from 4,4′-oxydianiline (ODA) and pyromellitic dianhydride, and containing 2-(dimethylamino)ethyl methacrylate.

There is a need for polymerizable polymers with the right set of thermal properties (Tm and Tg) and compositions to be used in lithographic processes which are the capable of producing 3D articles that present good mechanical properties after photofabrication and a substantial retention of these mechanical properties after exposure to high temperature, for example above 150° C. There is also a need for polymerizable polymers and compositions well-suited for high temperature 3D printing processes, notably that are thermally stable at temperatures required to thermally induce flow of the polymers.

### BRIEF DESCRIPTION OF THE FIGURES

FIG. 1 is a photorheology plot of a formulation according to the invention showing the storage modulus (G′, Pa) and the loss modulus (G″, Pa) vs time (s) during photopolymerization.

### DISCLOSURE OF THE INVENTION

In the present application:
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents; and
while certain compounds are represented according to a certain chemical representation, it should be understood that all isomers of the compounds are hereby covered by the present formula.

According to a first aspect, the present invention relates to poly(amide imide) (PAI) precursor polymers, which can for example be used in lithographic processes for the photofabrication of three-dimensional (3D) articles.

VAT photopolymerization is an additive manufacturing process that works by focusing an ultraviolet (UV) light or visible light, on a vat of crosslinkable photopolymer resin. Then complex three-dimensional (3D) structures can be built in a layer-by-layer fashion.

The PAI precursor polymer of the invention can be 3D printed to manufacture articles, for example using Vat photopolymerization processes such as lithographic processes (or stereolithography technology, SLA), the ink-jet technology, direct ink writing (DIW) or digital light processing (DLP).

The PAI precursor polymer of the present invention may notably be in the form of a liquid, a powder, or pellets.

Since the PAI precursor polymer notably contains PAI recurring units, the printed material has been shown to exhibit properties, notably mechanical properties, similar to PAI polymers as such.

The poly(amide imide) (PAI) precursor polymer (P1) of the present invention comprises recurring units p, q and r according to formula (I):

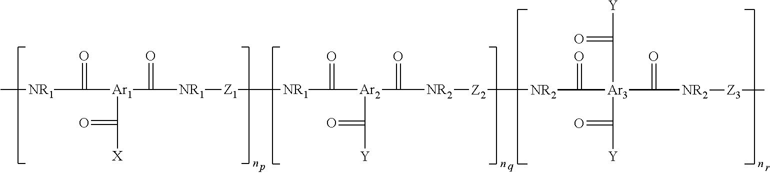

wherein
   nₚ, n_{q} and nᵣ are respectively the mole % of each recurring units p, q and r;
   recurring units p, q and r are arranged in blocks, in alternation or randomly;
   0≤nₚ≥100 mol. %;
   0≤n_{q}≥100 mol. %;
   nᵣ is ≥0 mol. %;
   wherein the mol. % are based on the total number of moles in the PAI precursor polymer,
Ar₁ and Ar₂, independently from each other, are trivalent aromatic moieties selected from the group consisting of substituted or unsubstituted, saturated, unsaturated or aromatic monocyclic and polycyclic groups having 5 to 50 carbon atoms;
Ar₃ is a tetravalent aromatic moiety selected from the group consisting of a substituted or unsubstituted, saturated, unsaturated or aromatic monocyclic and polycyclic group having 5 to 50 carbon atoms;
Z₁, Z₂ and Z₃, independently from each other, are substituted and unsubstituted divalent organic radicals, optionally comprising one or several heteroatoms,
R₁ and R₂, independently from each other, are H or an alkyl, preferably H or an alkyl having 1 to 5 carbon atoms, more preferably H;
X is OR₃, Cl, Br, F or I with R₃ being H or an alkyl, preferably an H or an alkyl having 1 to 5 carbon atoms;
Y is selected from the group consisting of:
   O—(CH₂)ₖ—O—CO—CH═CHR₄, with k being from 1 to 20, preferably from 1 to 8, more preferably from 2 to 6, even more preferably equal to 2 or 3; and R₄ being H or an alkyl, preferably an alkyl having 1 to 5 carbon atoms;
   O—(CH₂)ₚ—Ar—CR₅═CHR₆ or O—(CH₂)ₚ—OAr—CR₅═CHR₆, wherein p is from 0 to 20, preferably from 1 to 8; Ar comprises one or two aromatic or heteroaromatic rings; R₅ and R₆ are H, an alkyl, preferably an alkyl having 1 to 5 carbon atoms, a phenyl or a COOR_{z} with R_{z} being H or an alkyl, preferably an alkyl having 1 to 5 carbon atoms;
   O—(CH₂)_{q}—CH═CHR₈ with q being from 0 to 20, preferably from 1 to 8; and R₈ being H or an alkyl, preferably an alkyl having 1 to 5 carbon atoms;
   O—(CH₂)ᵣ—O—CH═CHR₉ with r being from 0 to 20, preferably from 1 to 8; and R₉ being H or an alkyl, preferably an alkyl having 1 to 5 carbon atoms;

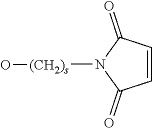

with s being from 0 to 20, preferably from 1 to 8;
O—, NRₐR_{b}R_{c}H⁺—(CH₂)ₖ—O—CO—CH═CHR₄, with k and R₄ as above-defined;
O—, PRₐR_{b}R_{c}H⁺—(CH₂)ₖ—O—CO—CH═CHR₄, with k and R₄ as above-defined;
O—, NRₐR_{b}R_{c}H⁺—(CH₂)ₚ—Ar—CR₅═CHR₆, with p, Ar, R₅ and R₆ as above-defined;
O—, NRₐR_{b}R_{c}H⁺—(CH₂)ₚ—OAr—CR₅═CHR₆ with p, Ar, R₅ and R₆ as above-defined;
O—, NRₐR_{b}R_{c}H⁺—(CH₂)_{q}—CH═CHR₈, with q and R₈ as above-defined;
O—, NRₐR_{b}R_{c}H⁺—(CH₂)—O—CH═CHR₉, with r and R₉ as above-defined;

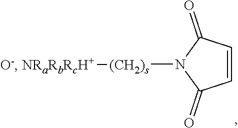

with s as above-defined;
wherein Rₐ, R_{b}, and R_{c} are independently H or an alkyl, preferably an alkyl having from 1 to 5 carbon atoms.

The PAI polymer of the present invention is such that it at least comprises recurring units p and q. It is therefore possible to adjust the degree of a crosslinking and make the object under printing tougher (less brittle) when needed, as it can happens that too much crosslinking from too many reactive acrylates can embrittle the material. The PAI polymer offers the possibility to fine tune the total acrylate level, and therefore enable to balance and optimize printing vs. material properties.

In some embodiments, the PAI precursor polymer of the present invention comprises recurring units q in a molar ratio such that the polymer comprises 50 mol. % of or more of recurring units q, based on the total number of moles in the polymer. According to these embodiments, 50 mol. %≤n_{q}≤100 mol. %. The PAI precursor polymer may for example comprises 60 mol. % or more or recurring units q, 70 mol. % or more, 80 mol. % or more, 90 mol. % or more, 95 mol. % or more.

In some embodiments, the PAI precursor polymer of the present invention comprises recurring units p and q in a molar ratio such that the polymer comprises 50 mol. % of or more of recurring units p and q, based on the total number of moles in the polymer. According to these embodiments, 50 mol. %≤(nₚ+n_{q})≤100 mol. %. The PAI precursor polymer may for example comprises 60 mol. % or more or recurring units p and q, 70 mol. % or more, 80 mol. % or more, 90 mol. % or more, 95 mol. % or more. In these embodiments, nₚ and n_{q} are such that n_{q}>0 mol. % and nₚ>0 mol. %, for example n_{q}>10 mol. % and nₚ>0 mol. % or n_{q}>50 mol. % and nₚ>10 mol. %.

In some embodiments, the PAI polymer of the present invention comprises recurring units p, q and r in a molar ratio such that the polymer comprises 50 mol. % of or more of recurring units p, q and r, based on the total number of moles in the polymer. According to these embodiments, 50 mol. %≤(nₚ+n_{q}+nᵣ)≤100 mol. %. The PAI polymer may for example comprises 60 mol. % or more or recurring units p, q and r, 70 mol. % or more, 80 mol. % or more, 90 mol. % or more, 95 mol. % or more. In these embodiments, nₚ, nₚ and nᵣ are such that n_{q}>0 mol. %, nₚ>0 mol. % and nᵣ≥0 mol. %, for example n_{q}>10 mol. %, nₚ>0 mol. % and nᵣ>0 mol. %; or n_{q}>50 mol. % and nₚ>0 mol. %, nᵣ>10 mol. %.

In some embodiments, the PAI precursor polymer of the present invention consists essentially in recurring units q. According to these embodiments, n_{q} is comprised between 95 and 100 mol. %, for example between 96 and 99.5 mol. %, between 97 and 99 mol. % or between 98 and 98.5 mol. %.

In some embodiments, the PAI precursor polymer of the present invention consists essentially in recurring units p and q. According to these embodiments, the sum of n_{q} and nₚ is comprised between 95 and 100 mol. %, for example between 96 and 99.5 mol. %, between 97 and 99 mol. % or between 98 and 98.5 mol. %.

In some embodiments, the PAI precursor polymer of the present invention consists essentially in recurring units p, q and r. According to these embodiments, the sum of (n_{q}+nₚ+nᵣ) is comprised between 95 and 100 mol. %, for example between 96 and 99.5 mol. %, between 97 and 99 mol. % or between 98 and 98.5 mol. %.

The PAI precursor polymer of the present invention may also comprise further recurring units. For example, the PAI precursor polymer of the present invention may comprise recurring units s according to formula (Rs):

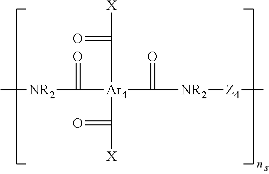

wherein
   nₛ is the mole % of the recurring units s;
   recurring units s are arranged in blocks, in alternation or randomly with respect to the other recurring units of the precursor polymer;
   nₛ is ≥0 mol. %;
   wherein the mol. % are based on the total number of moles in the PAI precursor polymer,
Ar₄ is a tetravalent aromatic moiety selected from the group consisting of a substituted or unsubstituted, saturated, unsaturated or aromatic monocyclic and polycyclic group having 5 to 50 carbon atoms;
Z₄ is a substituted and unsubstituted divalent organic radical, optionally comprising one or several heteroatoms,
R₂, independently from each other, are H or an alkyl, preferably H or an alkyl having 1 to 5 carbon atoms, more preferably H; and
X is OR₃, Cl, Br, F or I with R₃ being H or an alkyl, preferably an H or an alkyl having 1 to 5 carbon atoms.

Recurring units p and q comprise trivalent aromatic moieties Ar₁ and Ar₂ which are saturated, unsaturated or aromatic monocyclic and polycyclic groups having 5 to 50 carbon atoms, which can be substituted or unsubstituted. These groups are preferably aromatic groups selected from the group consisting of:

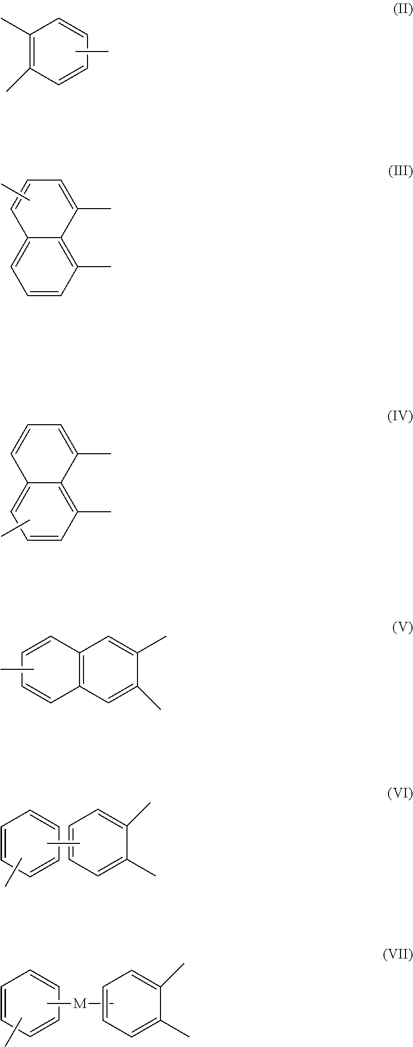

wherein
M is a divalent moiety selected from the group consisting of:
   alkylenes having 1 to 6 carbon atoms, preferably —C(CH₃)₂ and —CₙH₂ₙ— with n being an integer from 1 to 6;
   perfluoroalkylenes having 1 to 6 carbon atoms, preferably —C(CF₃)₂ and —CₙF₂ₙ— with n being an integer from 1 to 6;
   cycloalkylenes having 4 to 8 carbon atoms;
   alkylidenes having 1 to 6 carbon atoms;
   cycloalkylidenes having 4 to 8 carbon atoms;
   —O—; —S—; —C(O)—; —SO₂—; —SO—; and
   a group of the formula —O—Ar₄—O—, with Ar₄ having one or several substituted or unsubstituted, saturated, unsaturated or aromatic monocyclic and polycyclic groups, each group having 5 to 50 carbon atoms.

Preferably, the trivalent aromatic moieties Ar₁ and Ar₂ of recurring units p and q are according to formula (II) above.

Recurring units p, q and r respectively comprise divalent groups Z₁, Z₂ and Z₃, which are substituted and unsubstituted divalent organic radicals, optionally comprising one or several heteroatoms, and wherein the divalent groups are, independently from each other, preferably selected from the group consisting of formulas (i) to (v):

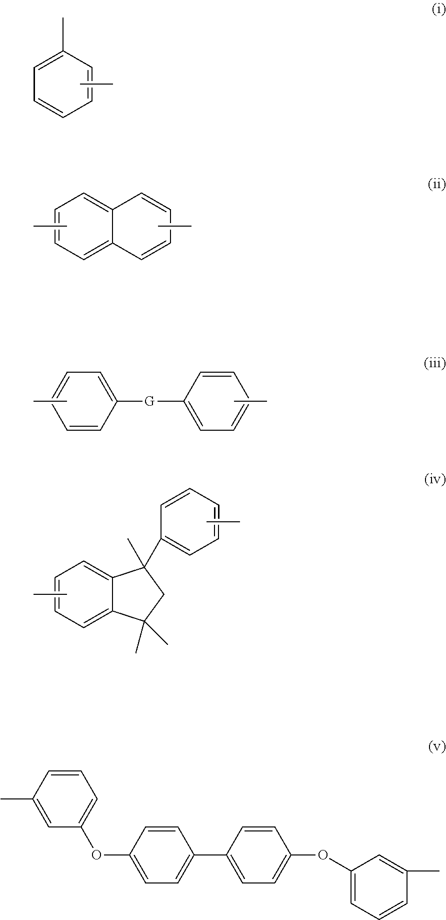

wherein
G is selected from the group consisting of:
   alkylenes having 1 to 6 carbon atoms, preferably —C(CH₃)₂ and —CₙH₂ₙ— with n being an integer from 1 to 6;
   perfluoroalkylenes having 1 to 6 carbon atoms, preferably —C(CF₃)₂ and —CₙF₂ₙ— with n being an integer from 1 to 6;
   cycloalkylenes having 4 to 8 carbon atoms;
   alkylidenes having 1 to 6 carbon atoms;
   cycloalkylidenes having 4 to 8 carbon atoms;
   —O—; —S—; —C(O)—; —SO₂—; —SO—.

More preferably, recurring units p, q and r respectively comprise groups divalent organic radical of Z₁, Z₂ and Z₃, at least one of which being according to formula (VIII):

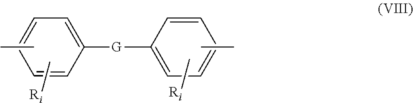

wherein
G is selected from the group consisting of:
   alkylenes having 1 to 6 carbon atoms, preferably —C(CH₃)₂ and —CₙH₂ₙ— with n being an integer from 1 to 6;
   perfluoroalkylenes having 1 to 6 carbon atoms, preferably —C(CF₃)₂ and —CₙF₂ₙ— with n being an integer from 1 to 6;
   cycloalkylenes having 4 to 8 carbon atoms;
   alkylidenes having 1 to 6 carbon atoms;
   cycloalkylidenes having 4 to 8 carbon atoms;
   —O—; —S—; —C(O)—; —SO₂—; —SO—; and
R is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium and
i, for each R, is independently zero or an integer ranging from 1 to 4.

Even more preferably, recurring units p, q and r respectively comprise Z₁, Z₂ and Z₃, in which at least one of Z₁, Z₂ and/or Z₃ is according to formula (VIII):

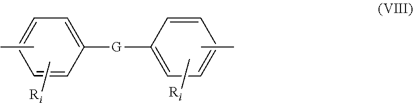

wherein
I is zero and
G is an alkylene of formula —CₙH₂ₙ— with n being an integer from 1 to 6, preferably 1 or 2.

In embodiments wherein at least one of Z₁, Z₂ and/or Z₃ is according to formula (i), (ii) or (iii), for example phenylene (C₆H₆), the divalent groups may be in position ortho (e.g. 1,2-aminophenyl), meta (e.g. 1,3-aminophenyl), or para (e.g. 1,4-aminophenyl) with respect to the polymer chain, preferably in position para (e.g. 1,4-aminophenyl) with respect to the carbon chain.

The PAI precursor polymer (P1) may have a number average molecular weight (Mn) (as measured by gel permeation chromatography (GPC) using DMF as a mobile phase, with polystyrene standards) of:
less than 100,000 g/mol, less than 90,000 g/mol or less than 90,000 g/mol; and/or
more than 1,000 g/mol, more than 2,000 g/mol or more than 3,000 g/mol.

According to an embodiment, the PAI precursor polymer (P1) of the present invention has a Tg ranging from 120 and 300° C., preferably from 170 and 295° C., more preferably from 200 and 290° C., even more preferably from 250 to 285° C. as measured by differential scanning calorimetry (DSC) according to ASTM D3418.

According to a second aspect of the present invention, the PAI precursor polymer (P1) described above may be incorporated in a formulation (F) to be used in photofabrication processes. In particular, the polymer (P1) and formulation (F) of the present invention can be incorporated into lithographic processes in which light is used to cure or crosslink the functionalized polymers.

The cross-linking ability of the formulation of the present invention can be assessed by photo-rheology. The formulation (F) of the present invention transforms from a liquid to a solid upon printing, e.g. upon irradiating the formulation with light, for example UV light or visible light. The change can be measured by a rotational rheometer. The transition from liquid resin to solid manifests itself in an increase of the storage modulus G′ and the loss modulus G″. The crossover of G′ and G″ approximated the gel point, which signified the transformation of a liquid to a gel upon network formation. The gel point is a critical engineering parameter to achieve quality printed structures. The measurement of G′ and G″ on the formulations therefore allows to assess the stiffness of the printed part, and therefore its ability to withstand the next layer of printed resin, and the solid-to-liquid transition time.

The cross-linking ability of the formulation of the present invention can be assessed by photorheology. The formulation (F) of the present invention transforms from a liquid to a solid upon printing, e.g. upon irradiating the formulation with light, for example UV light or visible light. The change can be measured by a rotational rheometer. The transition from liquid resin to solid manifests itself in an increase of the storage modulus G′ and the loss modulus G″. The crossover of G′ and G″ approximated the gel point, which signified the transformation of a liquid to a gel upon network formation. The gel point is a critical engineering parameter to achieve quality printed structures. The measurement of G′ on the formulations allows the assessment of the stiffness of the printed part, and therefore their ability to support the next layer of printed resin. The crossover of G′ and G″ gives an indication of the crosslinking speed and the liquid-to-solid transition time.

The concentration of the PAI precursor polymer of the present invention in the formulation (F) may be between 5 to 60 wt. %, based on the total weight of the formulation (F), for example between 8 and 50 wt. %, between 10 and 40 wt. %, or between 15 and 40 wt. %.

The formulation (F) of the present invention also comprises:
at least one solvent;
optionally one photosensitizer;
optionally one photoinitiator;
optionally one blocker.

The formulation (F) of the present invention is preferably liquid, for example at room temperature or above.

The formulation (F) can have a large viscosity range, which depends on the type of 3D printing method used. For example the viscosity of the formulation (F) may vary between 0.01 and 10,000 Pa·s. The viscosity of the formulation (F) preferably ranges between 0.01 and 10 Pa·s when the object is printed via stereolithography (SLA). The viscosity of the formulation (F) preferably ranges between 10 and 10,000 Pa·s when the object is printed via direct ink writing (DIW). The viscosity of the formulation (F) is preferably less than 0.1 Pa·s when the object is printed via ink-jetting.

According to the present invention, a photosensitizer is a compound that absorb the energy of light and act as donors by transferring this energy to acceptor molecules.

According to the present invention, a photoinitiator is a compound especially added to a formulation to convert absorbed light energy, UV or visible light, into chemical energy in the form of initiating species, for example free radicals or cations.

According to the present invention, a blocker is a compound added to either scavenge unused radicals created by the photoinitiator or absorb a portion of the incident light energy, for example UV light and visible light. This compound allows for improving dimensional accuracy of the fabricated part.

The formulation (F) of the present invention can comprise more than one polymer (P1), for example two of three distinct polymers (P1).

Solvent

The formulation (F) comprises at least one solvent. It may comprise more than one solvent, for example two solvents. The concentration of the solvent(s) may be between 1 to 95 wt. %, based on the total weight of the formulation (F), for example between 5 and 90 wt. %, between 15 and 80 wt. % or between 30 and 70 wt. %.

According to a first embodiment of the present invention, the solvent is selected from the group consisting of ortho-dichlorbenzene 1,2 dichloroethane, m-cresol, chlorobenzene, chloroform, N-methylpyrrolidone (NMP), N,N-dimethylformamide (DMF), N,N-dimethylacetamide (DMAC), 1,3-dimethyl-2-imidazolidinone, tetrahydrofuran (THF), dimethyl sulfoxide (DMSO) and sulfolane, γ-butyrolactone, γ-valerolactone, and mixtures thereof.

Preferably, the solvent is a dipolar aprotic solvent. Preferably, the solvent is selected from the group consisting of N-methylpyrrolidone (NMP), dimethylacetamide (DMAc or DMA), N-Cyclohexyl-2-pyrrolidone (CHP) and dimethyl sulfoxide (DMSO), sulfolane, and mixtures thereof.

According to a second embodiment, the solvent is water, ethanol, methanol, tertiary amines (trimethylamine, preferably N-Butyldiethanolamine, and amines as described in U.S. Pat. No. 6,479,581 B1), and/or ammonia (e.g. aqueous ammonia), and mixtures thereof.

According to this second embodiment, preferably the concentration of the PAI precursor polymer of the present invention in the formulation (F) may be between 1 to 80 wt. %, based on the total weight of the formulation (F), for example between 2 and 75 wt. %, between 5 and 70 wt. %, between 5 and 65 wt. %, between 10 and 65 wt. %, between 10 and 50 wt. %, 10 and 40 wt. %, between 10 and 35 wt. %, or between 12 and 33 wt. %.

According to a third embodiment, the solvent is a mixture of at least one solvent of the first embodiment as described above and at least one solvent of the second embodiment as described above. In other words, the solvent is a mixture of:
at least one solvent A selected from the group consisting of ortho-dichlorbenzene 1,2 dichloroethane, m-cresol, chlorobenzene, chloroform, N-methylpyrrolidone (NMP), N,N-dimethylformamide (DMF), N,N-dimethylacetamide (DMAC), 1,3-dimethyl-2-imidazolidinone, tetrahydrofuran (THF), dimethyl sulfoxide (DMSO) and sulfolane, γ-butyrolactone and γ-valerolactone, and
at least one solvent B selected from the group consisting of water, ethanol, methanol, tertiary amines and ammonia.

Photosensitizer

According to the present invention, the photosensitizer is a compound especially added to a formulation to absorb the energy of light and act as donors by transferring this energy to acceptor molecules.

According to an embodiment of the present invention, the photosensitizer is selected from the group consisting of benzophenones, acetophenones, triphenylene, fluoroenone, anthraquinone, triphenylamine, phenathrene, 9-anthracene methanol and mixtures thereof. The photosensitizer is preferably selected from the group consisting of benzophenones, anthraquinone, 9-anthracene methanol and mixtures thereof.

The concentration of the photosensitizer in the formulation (F) may be between 0.01 to 10 wt. %, based on the total weight of the formulation (F), for example between 0.1 and 5 wt. %, between 0.2 and 4 wt. %, or between 0.5 and 3 wt. %.

Photoinitiator

According to the present invention, the photoinitiator is a compound especially added to a formulation to convert absorbed light energy such as UV or visible light, into chemical energy in the form of initiating species, for example free radicals or cations. Based on the mechanism by which initiating radicals are formed, photoinitiators are generally divided into two classes:
Type I photoinitiators undergo a unimolecular bond cleavage upon irradiation to yield free radicals,
Type II photoinitiators undergo a bimolecular reaction where the excited state of the photoinitiator interacts with a second molecule (a coinitiator) to generate free radicals.

The concentration of the photoinitiator in the formulation (F) may be between 0.01 to 10 wt. %, based on the total weight of the formulation (F), for example between 0.1 and 5 wt. %, between 0.2 and 4 wt. %, or between 0.5 and 3 wt. %.

According to an embodiment of the present invention, the photoinitiator is selected from the group consisting of phospine oxides, organometallics, benzophenones, thioxanthones, phosphinates, hydroxy ketones, phosphine oxide+cyanoacrylates, phosphine oxide+phospinates and mixtures thereof, preferably phospine oxides.

According to an embodiment of the present invention, the photoinitiator is selected from the group consisting of
Acetophenone
Anisoin
Anthraquinone
Anthraquinone-2-sulfonic acid, sodium salt monohydrate
(Benzene) tricarbonylchromium
Benzil
Benzoin
Benzoin ethyl ether, Benzoin isobutyl ether, Benzoin methyl ether and Benzophenone
3,3′,4,4′-Benzophenonetetracarboxylic dianhydride
4-Benzoylbiphenyl
2-Benzyl-2-(dimethylamino)-4′-morpholinobutyrophenone
4,4′-Bis(diethylamino)benzophenone
4,4′-Bis(dimethylamino)benzophenone
Camphorquinone
2-Chlorothioxanthen-9-one
(Cumene)cyclopentadienyliron(II) hexafluorophosphate
Dibenzosuberenone
2,2-Diethoxyacetophenone
4,4′-Dihydroxybenzophenone
2,2-Dimethoxy-2-phenylacetophenone
4-(Dimethylamino)benzophenone
4,4′-Dimethylbenzil
2,5-Dimethylbenzophenone
3,4-Dimethylbenzophenone
Diphenyl(2,4,6-trimethylbenzoyl)phosphine oxide, 2-Hydroxy-2-methylpropiophenone and blends (e.g. 50/50 blend)
Blends of bis(2,4,6-trimethylbenzoyl)-phenylphosphineoxide and 2-hydroxy-2-methyl-1-phenyl-propan-1-one
Blends of ethyl phenyl(2,4,6-trimethylbenzoyl)phosphinate and phenyl bis(2,4,6-trimethylbenzoyl)-phosphine oxide
4′-Ethoxyacetophenone
2-Ethylanthraquinone
Ferrocene
3′-Hydroxyacetophenone, 4′-Hydroxyacetophenone, 3-Hydroxybenzophenone and 4-Hydroxybenzophenone
1-Hydroxycyclohexyl phenyl ketone
2-Hydroxy-2-methylpropiophenone
2-Methylbenzophenone or 3-Methylbenzophenone
Methybenzoylformate
2-Methyl-4′-(methylthio)-2-morpholinopropiophenone
2-Hydroxy-4′-(2-hydroxyethoxy)-2-methylpropiophenone
2-Benzyl-2-(dimethylamino)-4′-morpholinobutyrophenone
Phenanthrenequinone
4′-Phenoxyacetophenone
Phenylbis(2,4,6-trimethylbenzoyl)phosphine oxide
Thioxanthen-9-one
2-Isopropylthioxanthone
Lithium phenyl(2,4,6-trimethylbenzoyl)phosphinate
Triarylsulfonium hexafluoroantimonate salts, mixed, 50% in propylene carbonate
Triarylsulfonium hexafluorophosphate salts, mixed, 50% in propylene carbonate, and
2,4,5,7-Tetraiodo-3-hydroxy-9-cyano-6-fluorone
2,4,5,7-Tetraiodo-3-hydroxy-6-fluorone
5,7-diiodo-3-butoxy-6-fluorone, and
mixtures thereof.

Preferably, the photoinitiator is selected from the group consisting of 2,2-dimethoxy-2-phenylacetophenone (DMPA), diphenyl(2,4,6-trimethylbenzoyl)phosphine oxide, phenylbis(2,4,6-trimethylbenzoyl)phosphine oxide and mixtures thereof.

More preferably, the photoinitiator is diphenyl(2,4,6-trimethylbenzoyl)-phosphine oxide and/or phenylbis(2,4,6-trimethylbenzoyl)phosphine oxide.

When the solvent is water and/or ammonia (e.g. aqueous ammonia), the photoinitiator is preferably selected from the group consisting of alpha-hyrdoxy ketone, phosphinate salts, acyl phosphine oxides, ferric hydroxide, thioxanthone derivatives, benzophenone derivatives, acyl germanes, bis (acyl) phosphane oxides, phenylglyoxylate and mixtures thereof. Examples of such photoiniators are as follows: 2-Hydroxy-4′-(2-hydroxyethoxy)-2-methylpropiophenone, 4-(bis(2,4,6 trimethyl benzoyl) phosphinate salts, Li-phenyl(2,4,6-trimethylbenzoyl)phosphinate, MAPO-mono acyl phosphine oxides, BAPO-bis acyl phosphine oxides, iron(III) hydroxide, thioxanthane ammonium salts, 4-(trimethyl ammonium)methyl benzophenone chloride, bis-, tris-, or tetra-acyl germanes, sodium bis(acyl)phosphane oxides, and 2-[2-(2-oxo-2-phenylacetyl)oxyethoxy]ethyl 2-oxo-2-phenylacetate.

Blocker

According to the present invention, a blocker is a compound that is added to the formulation in order to (i) scavenge a predetermined amount of radicals formed by the photoinitiator while irradiated by light, (ii) scavenge unused radicals that may be present after the light irradiation source has been turned off, and/or (iii) absorb a portion of the energy that is delivered to the system during light irradiation.

The concentration of the blocker in the formulation (F) may be between 0.05 to 10 wt. %, based on the total weight of the formulation (F), for example between 0.1 and 5 wt. %, between 0.2 and 4 wt. % or between 0.5 and 3 wt. %.

According to an embodiment of the present invention, the blocker is selected from the group consisting of thiophene, naphthol, dihydrochalcones, phenol, metal oxides, sulfonic acids, sulfonic salts, benzophenones, benzotriazoles, cyanoacrylates, diazines, triazine, benzoates, oxalanilide, azobenzones, and mixtures thereof.

According to an embodiment of the present invention, the blocker is selected from the group consisting of:
2-hydroxy-4-methoxy benzophenone (oxybenzene)
1-(4-methoxyphenyl)-3-(4-tert-butylphenyl)propane-1,3-dione (avobenzone)
disodium 2,2′-(1,4-phenylene)bis(6-sulfo-1H-benzimidazole-4-sulfonate) (bisdisulizole disodium)
hexyl 2-[4-(diethylamino)-2-hydroxybenzoyl]benzoate (diethylamino hydroxybenzoyl hexyl benzoate)
menthyl-o-aminobenzoate (menthyl anthranilate)
2,2′-[6-(4-methoxyphenyl)-1,3,5-triazine-2,4-diyl]bis{5-[(2-ethylhexyl)oxy]phenol} (bemotrizinol)
2,4-dihydroxybenzophenone
2,2′,4,4′-tetrahydroxybenzophenone
4-Hydroxy-2-methoxy-5-(oxo-phenylmethyl)benzenesulfonic acid (sulisobenzone)
2,2′-dihydroxy-4,4′-dimethoxybenzophenone
5-chloro-2-hydroxybenzophenone
(2-hydroxy-4-methoxyphenyl)-(2-hydroxyphenyl)methanone
(dioxybenzone)
2,5-Bis(5-tert-butyl-benzoxazol-2-yl)thiophene
sodium 2,2′-dihydroxy-4,4′-dimethoxybenzophenone-5,5′-disulfonate
(2-hydroxy-4-methoxyphenyl)(4-methylphenyl)methanone (mexenone)
(2-hydroxy-4-octoxy-phenyl)-phenyl-methanone (octabenzone)
2-(1,2,3-Benzotriazol-2-yl)-4-methyl-6-[2-methyl-3-(2,2,4,6,6-pentamethyl-3,5-dioxa-2,4,6-trisilaheptan-4-yl)propyl]phenol (drometrizole trisiloxane)
terephthalylidene dicamphor sulfonic acid (ecamsule)
2-ethylhexyl 2-cyano-3,3-diphenyl-2-propenoate (octocrylene)
diethylhexyl butamido triazone (iscotrizinole)
2-Ethoxyethyl 3-(4-methoxyphenyl)propenoate (cinoxate)
isopentyl 4-methoxycinnamate (amiloxate)
2,2′-methanediylbis[6-(2H-benzotriazol-2-yl)-4-(2,4,4-trimethylpentan-2-yl)phenol] (bisoctrizole)
2-(2H-benzotriazol-2-yl)-4-(1,1,3,3-tetramethylbutyl)phenol
2,2′-methylenebis[6-(2H-benzotriazol-2-yl)-4-(1,1,3,3-tetramethylbutyl)phenol]
2-hydroxy-4-(octyloxy)benzophenone
2-ethyl-, 2-[4-(4,6-diphenyl-1,3,5-triazin-2-yl)-3-hydroxyphenoxy]ethyl ester
2-tert-butyl-6-(5-chloro-2H-benzotriazol-2-yl)-4-methylphenol
2-(2-hydroxy-5-methylphenyl)benzotriazole
2,4-dinitrophenylhydrazine
N-(4-ethoxycarbonylphenyl)-N′-methyl-N′-phenylformamidine
hexadecyl 3,5-bis-tert-butyl-4-hydroxybenzoate
2-ethyl-2′-ethoxy-oxalanilide, and
mixtures thereof.

Preferably, the blocker is selected from the group consisting of avobenzone, 2,5-Bis(5-tert-butyl-benzoxazol-2-yl)thiophene and mixtures thereof.

When the solvent is water and/or ammonia, the blocker is preferably selected from the group consisting of hydroxy phenyl triazines (HPT), benzotriazoles (BTZ), benzophenone-9 and mixtures thereof. Examples of such blockers are as follows: hydroxy phenyl benzotriazole, 2-hydroxy phenyl-s-triazine, 2-hydroxyphenyl-s-triazine, 2-(2-hydroxyphenyl)-benzotriazole, 2,2′-Dihydroxy-4,4′-dimethoxybenzophenone-5,5′-bis (sodium sulfonate), Disodium-2,2′-dihydroxy-4,4′-dimethoxy-5,5′-disulfobenzophenone and 2-hydroxy-4-methoxybenzophenone-5-sulfonic acid.

Optional Components

The formulation of the present invention may comprise at least one additive, for example selected from the group consisting of fillers such as silica, antioxidants, antibacterial compounds and antistatic compounds. The additive may for example be a chemically inert species such as carbon black, silica (e.g. microsilica particles) and carbon nano tubes.

According to a third aspect of the present invention, the PAI precursor polymer (P1) described above may be incorporated in a composition (C).

The composition (C) may comprise the PAI precursor polymer (P1) in an amount of at least 1 wt. %, for example at least 5 wt. %, at least 10 wt. %, at least 15 wt. %, at least 20 wt. %, at least 25 wt. %, or at least 30 wt. %, based on the total weight of the composition (C).

The composition (C) may comprise the PAI precursor polymer (P1) in an amount of more than 50 wt. %, for example more than 55 wt. %, more than 60 wt. %, more than 65 wt. %, more than 70 wt. %, more than 75 wt. %, more than 80 wt. %, more than 85 wt. %, more than 90 wt. %, more than 95 wt. % or more than 99 wt. %, based on the total weight of the composition (C).

According to an embodiment, the composition (C) comprises the PAI precursor polymer (P1) in an amount ranging from 1 to 99 wt. %, for example from 3 to 96 wt. %, from 6 to 92 wt. % or from 12 to 88 wt. %, based on the total weight of the composition (C).

The composition (C) may further optionally comprise one or more additional additives selected from the group consisting of light stabilizers (for example UV light stabilizers), photosensitizers, heat stabilizers, acid scavengers (i.e. zinc oxide, magnesium oxide), antioxidants, pigments, processing aids, lubricants, flame retardants, and/or conductivity additive (i.e. carbon black, carbon nanofibrils, graphite, copper, aluminum, zinc oxide, boron nitride, aluminum oxide, diamond and silver powders, and graphene).

The composition (C) may also further comprise other polymers than the PAI precursor polymer (P1) of the present invention, for example sulfone polymer, e.g. poly(biphenyl ether sulfone) (PPSU), polysulfone (PSU), polyethersulfone (PES), or a polyphenylene sulfide (PPS), a poly(aryl ether ketone) (PAEK), e.g. a poly(ether ether ketone) (PEEK), a polyether-imide (PEI), a polyimide (PI), a polyphenylene (SRP), a poly(ether ketone ketone) (PEKK), a poly(ether ketone) (PEK) or a copolymer of PEEK and poly(diphenyl ether ketone) (PEEK-PEDEK copolymer), another polyamide-imide polymer (PAI2), and/or polycarbonate (PC).

The composition (C) may further comprise flame retardants such as halogen and halogen free flame retardants.

The composition (C) may comprise glass fibers, for example E-glass fibers or high modulus glass fibers having an elastic modulus (also called tensile modulus of elasticity) of at least 76, preferably at least 78, more preferably at least 80, and most preferably at least 82 GPa as measured according to ASTM D2343. The composition (C) may also comprise high modulus glass fibers selected from the group consisting of R, S and T glass fibers, for example in an amount of at least 5 wt. %, for example at least 10 wt. %, at least 15 wt. %, at least 20 wt. %, at least 25 wt. %, at least 26 wt. %, or at least 28 wt. %, based on the total weight of the composition (C). The composition (C) may comprise circular cross-section glass fibers and/or non-circular cross-section glass fibers (e.g. flat, rectangular, cocoon-shaped glass fibers).

The composition (C) may comprise carbon fibers, graphene or carbon nanotubes.

The composition (C) can be made by methods well known to the person skilled in the art. For example, such methods include, but are not limited to, melt-mixing processes. Melt-mixing processes are typically carried out by heating the polymer components above the melting temperature of the thermoplastic polymers thereby forming a melt of the thermoplastic polymers.

In some embodiments, the processing temperature ranges from about 280-450° C., preferably from about 290-400° C., from about 300-360° C. or from about 310-340° C. Suitable melt-mixing apparatus are, for example, kneaders, Bradbury mixers, single-screw extruders, and twin-screw extruders.

Preferably, use is made of an extruder fitted with means for dosing all the desired components to the extruder, either to the extruder's throat or to the melt. The components of the polymer composition are fed to the melt-mixing apparatus and melt-mixed in that apparatus. The components may be fed simultaneously as a powder mixture or granule mixer, also known as dry-blend, or may be fed separately.

According to a fourth aspect, the present invention also relates to a process for preparing the PAI precursor polymer (P1) of the present invention.

According to a first embodiment, the process for preparing the PAI precursor polymer (P1) of the present invention, comprises reacting, in the presence of a polar aprotic solvent and an organic base:
a compound of formula (IX):

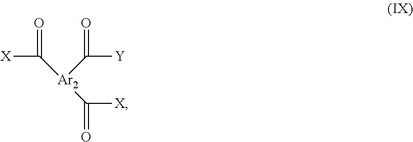

optionally with a compound of any one of formulas (X) and (XI):

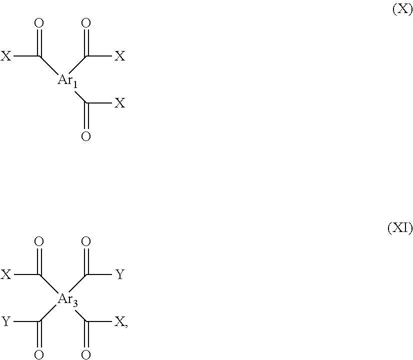

a compound of formula (XII):

NRₙRₘ—Z₂—NRₙRₘ (XII)

optionally with a compound of any one of formulas (XIII) or (XIV):

NRₙRₘ—Z₁—NRₙRₘ (XIII)

NRₙRₘ—Z₃—NRₙRₘ (XIV)

wherein:
Ar₁ and Ar₂, independently from each other, are trivalent aromatic moieties selected from the group consisting of substituted or unsubstituted, saturated, unsaturated or aromatic monocyclic and polycyclic groups having 5 to 50 carbon atoms;
Ar₃ is a tetravalent aromatic moiety selected from the group consisting of a substituted or unsubstituted, saturated, unsaturated or aromatic monocyclic and polycyclic group having 5 to 50 carbon atoms;
X is OR, Cl, Br, F or I with R being H or an alkyl, preferably an alkyl having 1 to 5 carbon atoms;
Rₐ and Rₘ, independently from each other, are H or an alkyl, preferably an alky having 1 to 5 carbon atoms;
Z₁, Z₂ and Z₂, independently from each other, are selected from the group consisting of substituted and unsubstituted divalent organic radicals, optionally comprising one or several heteroatoms,
Y is selected from the group consisting of:
   O—(CH₂)ₖ—O—CO—CH═CHR₄, with k being from 1 to 20, and R₄ being H or an alkyl;
   O—(CH₂)ₚ—Ar—CR₅═CHR₆ or O—(CH₂)ₚ—OAr—CR₅═CHR₆, wherein p is from 0 to 20, Ar comprises one or two aromatic or heteroaromatic rings, R₅ and R₆ are H or an alkyl, a phenyl or a COOR₇ with R₇ being H or an alkyl;
   O—(CH₂)_{q}—CH═CHR₈ with q being from 0 to 20, and R₈ being H or an alkyl;
   O—(CH₂)ᵣ—O—CH═CHR₉ with r being from 0 to 20 and R₉ being H or an alkyl;

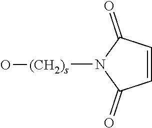

with s being from 0 to 20;
O—, NRₐR_{b}R_{c}H⁺—(CH₂)ₖ—O—CO—CH═CHR₄, with k and R₄ as above-defined;
O—, PRₐR_{b}R_{c}H⁺—(CH₂)ₖ—O—CO—CH═CHR₄, with k and R₄ as above-defined;
O—, NRₐR_{b}R_{c}H⁺—(CH₂)ₚ—Ar—CR₅═CHR₆, with p, Ar, R₅ and R₆ as above-defined;
O—, NRₐR_{b}R_{c}H⁺—(CH₂)ₚ—OAr—CR₅═CHR₆ with p, Ar, R₅ and R₆ as above-defined;
O—, NRₐR_{b}R_{c}H⁺—(CH₂)_{q}—CH═CHR₈, with q and R₈ as above-defined;
O—, NRₐR_{b}R_{c}H⁺—(CH₂)ᵣ—O—CH═CHR₉, with r and R₉ as above-defined;

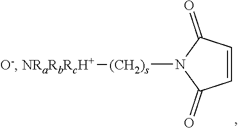

with s as above-defined;
wherein Rₐ, R_{b}, and R_{c} are independently H or an alkyl.

As stated above, while the compounds (notably compound of formula (IX)) are represented according to a certain chemical representation, all isomers of the compounds are intended to be hereby covered.

In some embodiments, the process for preparing the PAI precursor polymer (P1) of the present invention, also comprises reacting a compound of formula:

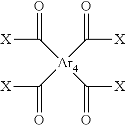

wherein Ar₄ and X are as above-defined.

In some embodiments, the solvent is selected from the group consisting of chlorobenzene, chloroform, N-methylpyrrolidone (NMP), N,Ndimethylformamide (DMF), N,N-dimethylacetamide (DMAC), 1,3-dimethyl-2-imidazolidinone, tetrahydrofuran (THF), dimethyl sulfoxide (DMSO) and sulfolane.

In some other embodiments, the organic base is selected from the group consisting of pyridine and alkylamine, for example trimethylamine.

According to a second embodiment, the process for preparing the PAI precursor polymer (P1) of the present invention comprises reacting, in the presence of a polar aprotic solvent and/or an aqueous solvent, and an organic base:
a PAI precursor polymer (PO) of formula RₙRₘN—P—NRₙRₘ, wherein P comprises recurring units p according to formula (XV):

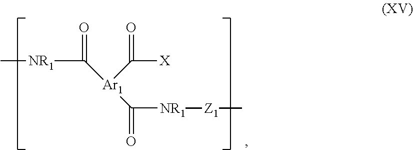

wherein:
Ar₁ is trivalent aromatic moieties selected from the group consisting of substituted or unsubstituted, saturated, unsaturated or aromatic monocyclic and polycyclic groups having 5 to 50 carbon atoms;
X is OR, Cl, Br, F or I with R being H or an alkyl, preferably an alkyl having 1 to 5 carbon atoms;
Rₐ and Rₘ, independently from each other, are H or an alkyl, preferably an alky having 1 to 5 carbon atoms;
R₁ is H or an alkyl, preferably H or an alkyl having 1 to 5 carbon atoms;
Z₁ is a substituted and unsubstituted divalent organic radical, optionally comprising one or several heteroatoms, with a compound selected from the group consisting of:
   NRₐR_{b}R_{c}—(CH₂)ₖ—O—CO—CH═CHR₄, with k and R₄ as above-defined,
   PRₐR_{b}R_{c}—(CH₂)ₖ—O—CO—CH═CHR₄, with k and R₄ as above-defined,
   NRₐR_{b}R_{c}—(CH₂)ₚ—Ar—CR₅═CHR₆, with p, Ar, R₅ and R₆ as above-defined,
   NRₐR_{b}R_{c}—(CH₂)ₚ—OAr—CR₅═CHR₆ with p, Ar, R₅ and R₆ as above-defined,
   NRₐR_{b}R_{c}—(CH₂)_{q}—CH═CHR₈, with q and R₈ as above-defined,
   NRₐR_{b}R_{c}—(CH₂)ᵣ—O—CH═CHR₉, with r and R₉ as above-defined,

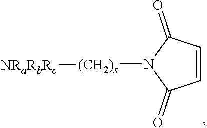

with s as above-defined,
wherein Rₐ, R_{b}, and R_{c} are independently H or an alkyl, preferably an alkyl having from 1 to 5 carbon atoms.

According to this second embodiment, the PAI precursor polymer (PO) is according to formula RₙRₘN—P—NRₙRₘ. Preferably, Rₐ and Rₘ are H and PO is according to formula H₂N—P—NH₂.

In embodiments wherein the amine moieties (NRₙRₘ or NH₂) are link to the polymer P via a group Z₁ according to formulas (i), (ii) or (iii) as above-described, e.g. a phenylene group (C₆H₆), the amine moieties may be in position ortho (e.g. 1,2-aminophenyl), meta (e.g. 1,3-aminophenyl), or para (e.g. 1,4-aminophenyl) with respect to the polymer chain P, preferably in position para (e.g. 1,4-aminophenyl) with respect to the carbon chain P.

According to a fifth aspect, the present invention also relates to a method for manufacturing a 3D article with an additive manufacturing system, comprising:
providing a polymer formulation (F) as above-described,
printing layers of the 3D article from the polymer formulation (F),
optionally, curing the 3D article at a temperature ranging from 50 to 450° C., preferably from 100 to 300° C., even more preferably between 120 and 180° C.

According to an embodiment, the step of printing comprises irradiating the polymer formulation (F), for example a layer of such formulation (F) deposited onto the printing surface, with light. For example, with UV light, the layer preferably presents a size in the range of 5 μm to 300 μm, for example 20 μm to 150 μm.

The light source can for example be laser light. The irradiation is preferably of sufficient intensity to cause substantial curing of the polymer formulation (F), for example the layer of such formulation (F). Also, the irradiation is preferably of sufficient intensity to cause adhesion of the layers of polymer formulation (F).

According to another embodiment of the present invention, the method for manufacturing a 3D article with an additive manufacturing system, comprises the steps of:
providing a polymer formulation (F) as above-described,
printing layers of the 3D article from the polymer formulation (F) by:
   a) coating a layer of the formulation (F) onto a surface,
   b) irradiating the layer with light, for example UV light or visible light,
   c) coating a layer of the formulation (F) onto the former irradiated layer,
   d) irradiating the layer with light, for example UV light or visible light, and
   e) repeating steps c) and d) a sufficient number of times to manufacture the 3D article.

According to an embodiment, the polymer formulation (F) is at room temperature during the process. Alternatively, the formulation can be heated before and/or during printing, especially if the polymer concentration in the formulation is high. In this case, the temperature can be heated up to 130° C., up to 120° C. or up to 110° C. before and/or during printing.

The present invention also relates to the use of the polymer (P1) of the present invention or of the polymer formulation (F) of the present invention, for the manufacture of 3D objects/articles.

All of the embodiments described above with respect to the polymer (P1) and the polymer formulation (F) do apply equally to the use for the manufacture of 3D objects/articles.

The present invention also relates to 3D objects or 3D articles obtainable, at least in part, from the method of manufacture of the present invention, using the polymer (P1) or the polymer formulation (F) herein described.

The 3D objects or articles obtainable by such method of manufacture can be used in a variety of final applications. Mention can be made in particular of implantable device, dental prostheses, brackets and complex shaped parts in the aerospace industry and under-the-hood parts in the automotive industry.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### EXAMPLES

### Experimental

Materials: Triethylamine (TEA) (Arcos Organics, ≥99%), sodium chloride (Fisher Chemical, certified ACS), 2-hydroxyethyl acrylate (HEA) (Sigma-Aldrich, 96%), tetrahydrofuran (THF) (Fisher Chemical, HPLC grade), diethyl ether anhydrous (DEE) (Fisher Chemical, certified ACS), dichloromethane anhydrous (DCM) (Arcos Organics, 99.9%), magnesium sulfate (Fisher Chemical, certified ACS), diphenyl(2,4,6-trimethylbenzoyl)phosphine oxide (TPO) (97%, Sigma Aldrich), oxalyl chloride (Arcos Organics, 98%), hydrochloric acid (Fisher Chemical, certified ACS), 4,4′-Diaminodiphenylmethane (MDA) (Sigma-Aldrich, ≥97%), Trimellitic anhydride chloride (TMAC) (Sigma-Aldrich, 98%) deuterated chloroform (CIL, 99.8%), deuterated dimethyl sulfoxide (D₆-DMSO) (CIL, 99.8%) and N,N-dimethylformamide (DMF) (Sigma-Aldrich, 99.9%), and N-methylpyrrolidone anhydrous (NMP) (Sigma-Aldrich, ≥99.5%), were used as received. N, N-Dimethylacetamide anhydrous (Arcos Organics, ≥99.5%) was stored over activated molecular sieves. Trimellitic anhydride (TMA) (TCI, >98%) and 4, 4′-oxydianiline (ODA) (TCI, ≥98%) were sublimed before use. Nitrogen gas (99.999%) was purchased from Praxair.

Analytical Methods:

¹H nuclear magnetic resonance (NMR) spectroscopy was performed at 25° C. using a Varian Unity 400 at 400 MHz or a Bruker Avance III HD at 400 Mhz. CDCl₃ or D₆-DMSO served as the solvent for NMR analysis.

Photorheology was performed using a TA Instruments DHR-2 rheometer with 20 mm parallel plate geometry, UV curing accessory, and Omnicure S2000 light source equipped with a broad spectrum bulb and 320-500 nm filter. An Oscillation procedure of 0.3% strain and 4 Hz at 25° C. was utilized during photorheology. Polymer solutions were subjected to oscillation for 30 s prior to UV irradiation with an intensity of 250 mW/cm² for 150 s.

Thermogravimetric analysis (TGA) was performed from 25° C. to 600° C. with a 10° C./min heating rate and N₂ fill gas using a TA instruments Q50.

Dynamic mechanical analysis (DMA) was performed on 3D printed bars and control films with a TA Instruments DMA Q800 in oscillatory tension mode at 1 Hz, 0.1% strain and 3° C./min heating ramp under air. T_{g}s were determined from peak of tan δ.

General procedure for the determination of molecular weight (Mn, Mw, Mz and Mz+1)

The molecular weights were measured by gel permeation chromatography (GPC), using N,N-dimethylformamide as a mobile phase. Two 5μ mixed D columns with guard column from Agilent Technologies were used for the separation. An ultraviolet detector of 254 nm was used to obtain the chromatogram. A flow rate of 1.5 ml/min and injection volume of 20 μL of a 0.2 w/v % solution in mobile phase was selected. Calibration was performed with 12 narrow molecular weight polystyrene standards (Peak molecular weight range: 371,000 to 580 g/mol). The number average molecular weight Mn, weight average molecular weight Mw, higher average molecular weight Mz and Mz+1, were reported.

### Synthesis of Acrylate Ester Dicarboxylic Acid of Trimellitic Anhydride

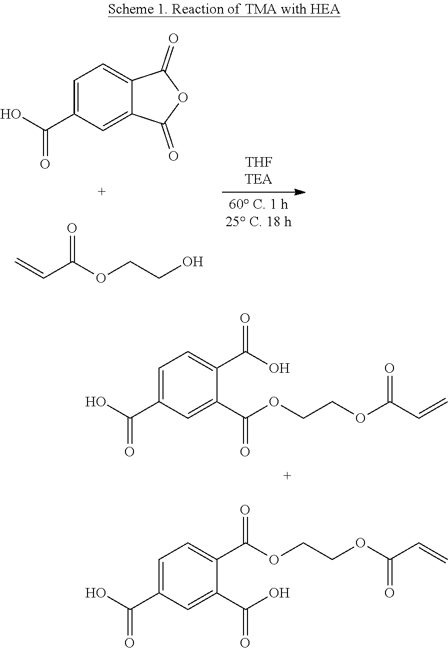

A 250 mL two-necked round-bottom flask equipped with a N₂ inlet, reflux condenser and magnetic stir bar was charged with TMA (25.00 g, 0.1301 mol), HEA (18.13 g, 0.1561 mol) and 80 mL of THF. The solution was stirred under nitrogen for 20 min at 25° C. before the addition of TEA (1.59 g, 0.0157 mol). The reaction mixture was then heated and allowed to react at 60° C. for 60 min. Following the 60 min, the reaction mixture was cooled and stirred at 25° C. for 18 h. The reaction mixture was then diluted with 100 mL DEE and 100 mL DI water before being transferred to a separatory funnel. The organic layer was collected and further extracted with 100 mL DI water, 100 mL of 1 M HCl and 100 mL of saturated NaCl/water solution. The organic layer was then dried over MgSO₄ and concentrated using rotary evaporation. The resulting white solid was further dried in vacuum oven at 30° C. overnight, yielding 32.05 g of a white solid (79.8% yield). The reaction afforded two isomers, para and meta, as depicted in Scheme 1, and ¹H NMR ascertained an isomeric ratio of 60% para and 40% meta. ¹H NMR assessed the purity of product: ¹H NMR (400 MHz, DMSO-d₆) δ 13.53 (s, 2H), 8.29 (dd, J=1.7, 0.5 Hz, 1H), 8.19-8.12 (m, 1H), 7.83 (dd, J=7.9, 0.6 Hz, OH), 7.71 (dd, J=7.9, 0.5 Hz, 1H), 6.37-6.28 (m, 1H), 6.21-6.11 (m, 1H), 5.92 (dd, J=10.3, 1.6 Hz, 1H), 4.53-4.44 (m, 2H), 4.43-4.35 (m, 2H).

### Synthesis of Acrylate Ester Diacid Chloride of Trimellitic Anhydride

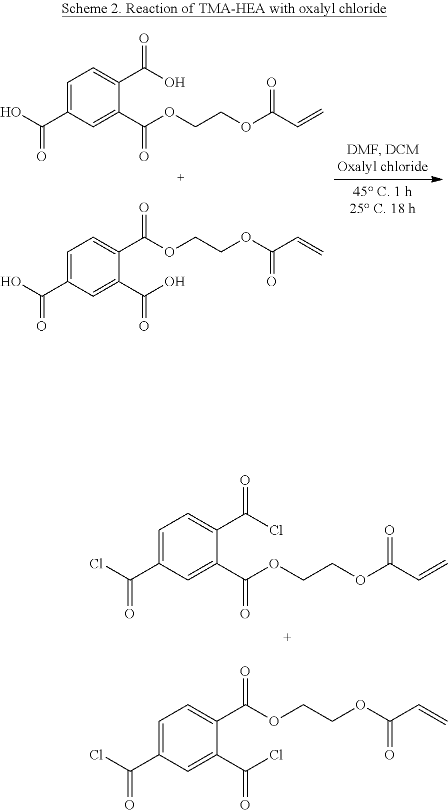 [SMILES: C=CC(=O)OCCOC(=O)c1cc(C(=O)O)ccc1C(=O)O ; C=CC(=O)OCCOC(=O)c1ccc(C(=O)O)cc1C(=O)O ; C=CC(=O)OCCOC(=O)c1cc(C(=O)Cl)ccc1C(=O)Cl ; C=CC(=O)OCCOC(=O)c1ccc(C(=O)Cl)cc1C(=O)Cl]

To a 500 mL three-necked round-bottom flask equipped with N₂ inlet, reflux condenser, magnetic stir bar and 6 M KOH base trap was added TMA-HEA (23 g, 0.0746 mol), DMF (0.25 g, 0.00342 mol) and 160 mL of anhydrous DCM. The resultant heterogeneous solution was stirred under N₂ flow for 1 h at 25° C. before dropwise addition of oxalyl chloride (19.87 g, 0.1567 mol). After 4 h of dropwise addition, the solution was heated to 45° C. and allowed to react for 1 h. The reaction was then cooled to 25° C. and the remaining oxalyl chloride was added dropwise over 3 h. The reaction was then stirred overnight yielding a slightly yellow, homogenous solution. The solution was concentrated using rotary evaporation and dried overnight in vacuum oven at 25° C. The resultant red viscous liquid (22.9 g, 88.9% yield) was analyzed by 1H NMR. Oxalyl chloride enabled conversion of the TMA-HEA dicarboxylic acid into reactive diacyl chloride monomers. 1H NMR (400 MHz, Chloroform-d) δ 8.62 (dd, J=1.9, 0.5 Hz, OH), 8.47 (dd, J=1.8, 0.5 Hz, 1H), 8.35 (m, J=8.2, 5.3, 1.8 Hz, 1H), 7.97 (dd, J=8.2, 0.5 Hz, 1H), 7.78 (dd, J=8.2, 0.5 Hz, OH), 6.44 (dd, J=17.3, 3.1, 1.4 Hz, 1H), 6.14 (m, J=17.4, 10.5, 3.1 Hz, 1H), 5.87 (dd, J=10.5, 1.4, 1.0 Hz. 1H). 4.64-4.57 (m, 2H), 4.50-4.45 (m, 2H).

### PAI #1—Synthesis of poly(amide amic acrylate ester) of trimellitic anhydride and 4,4′-diaminodiphenylmethane (PAI Precursor Polymer Comprising Recurring Units q)

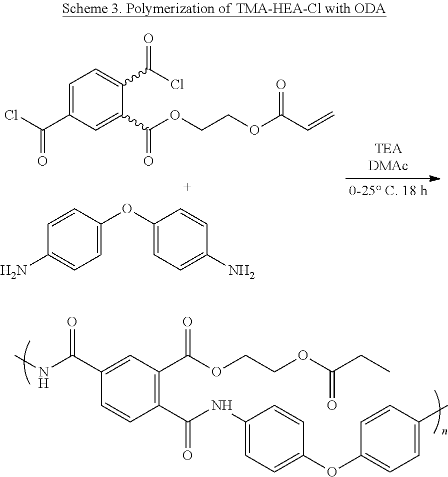

ODA (13.532 g, 0.06758 mol), TEA (13.677 g, 0.1352 mol) and 200 mL DMAc were added to a flame-dried, 500-mL round-bottomed flask equipped with N₂ inlet and magnetic stir bar. The flask was then cooled to 0° C. while stirring under N₂ flow before addition of chilled solution of TMA-HEA-CI (23.324 g, 0.06758 mol) and 100 mL DMAc. The resultant solution was stirred under N₂ flow for 18 h before being dropwise precipitated into cold methanol.

The yellow precipitate was collected via vacuum filtration and dried in a vacuum oven at 30° C. for 2 d. The molecular structure of the obtained yellow powder was assessed by ¹H NMR. ¹H NMR (400 MHz, DMSO-d6) δ 10.71-10.49 (m, 2H), 8.33-8.12 (m, 2H), 8.02-7.94 (m, 1H), 7.86-7.65 (m, 4H), 7.04 (td, J=9.0, 4.0 Hz, 4H), 6.35-6.24 (m, 1H), 6.07 (dd, J=17.2, 10.4, 3.6 Hz, 1H), 5.89 (dd, J=10.4, 5.5, 1.5 Hz, 1H), 4.48 (d, 2H), 4.32 (d, 2H). Mw=62,611 g/mol; Mw/Mn=1.73

### PAI #2—Synthesis of poly(amide amic acrylate ester) of trimellitic anhydride and 4,4′-diaminodiphenylmethane (PAI Precursor Polymer Comprising Recurring Units p and q in a Molar Ratio 75/25)

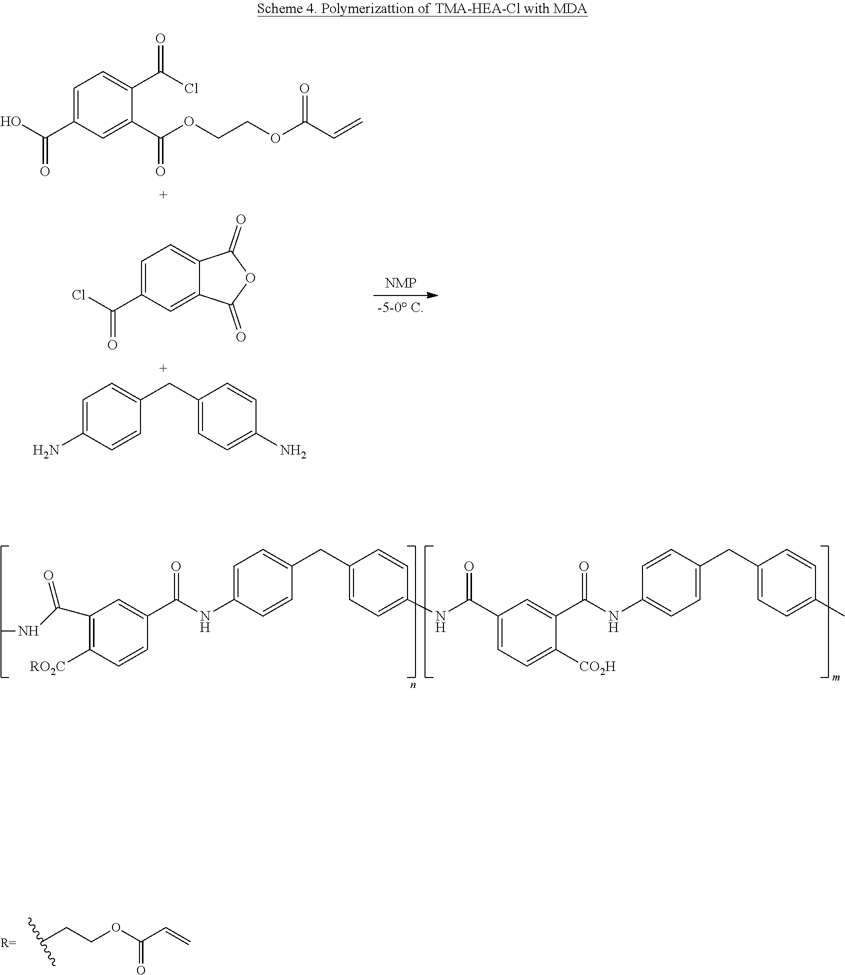

To a 500 mL three-neck full-jacketed flask equipped with N₂ inlet/outlet, mechanical stirrer, addition funnel and thermal couple was added ODA (108.5 g, 0.547 mol), TEA (57.0 g, 0.550 mol) and 600 g anhydrous NMP. Upon dissolution of the ODA, the flask was then cooled to −5° C. before the dropwise addition of a solution consisting of TMA-HEA-CI (47.5 g, 0.1375 mol) and TMAC (86.9 g, 0.4125 mol) in 175 g of anhydrous NMP over 2.75 h (maintain temp.<0° C.). After complete addition, the addition funnel was washed with 50 mL NMP and the reaction was held at 0° C. for 0.5 h. The resultant amber solution was then discharged from the reactor flask and was coagulated into 3 L of DI water using a Warring blender. The resulting precipitate was collected via vacuum filtration and washed three times with 3 L of water and then washed four times with 3 L of methanol. After washing, the powder was then dried under reduced pressure in oven at 35° C., −25 inHg for 48 h yielding 223 g (84% yield) of a light yellow powder. Mw=71,760 g/mol; Mw/Mn=1.91. Acrylate amount detected by NMR=28 mol. %.

Drying and Imidization of Crosslinked TMA-HEA-ODA Samples:

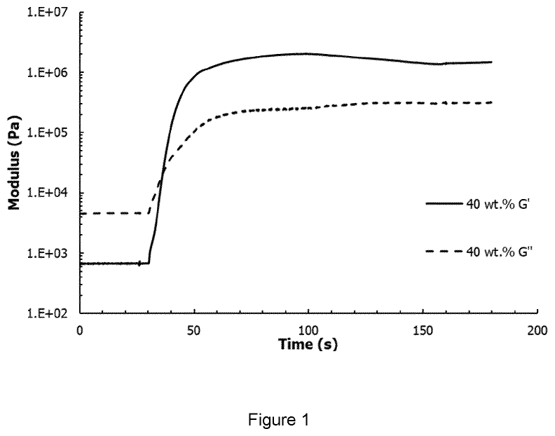

40 wt. % PAI #1 solution in NMP with 2.5 wt. % TPO relative to PAI #1 was crosslinked using photo-rheology (FIG. 1).

From the photo-rheology, it was determined that the cross-over time for the solution was about 5 s with plateau storage modulus G′ of higher than 10⁶ Pa. The cured samples were allowed to dry at room temperature over 2 days while under constant air flow. The partially dried gels were then placed on a perforated metal stage, and heated in a vacuum oven (45 mmHg) to 25° C., 60° C., 100° C. and 150° C., for 1 h each. The samples were then transferred into a glass vacuum chamber in a bismuth/tin metal bath and heated under reduced pressure at 240° C. and 300° C. for 1 h. The sample became opaque and red during the heat treatment; however, the overall shape was retained and no cracks formed. TGA ascertained a T_{d5%} of 400° C. for the heat treated sample. DMA analysis of the heat treated part produced a Tg of 265° C. The produced glass transition temperatures indicated residual poly(HEA) decreased the glass transition when compared to thin films of the control TMA-ODA PAI (T_{g}=about 290° C.).

Direct Ink Write (DIW-UV Assisted) of PAAAE Resins

Printer: A custom-built Ultraviolet-Assisted Direct Ink Write (UV-DIW) platform was used to print the synthesized PAAAE solutions. The printer incorporates a Nordson EFD Ultimus V DIW system to extrude material and a Keynote Photonics LC4500-UV Digital Light Processing (DLP) projector to cure the extruded material. The projector provides UV irradiation at 405 nm and a measured intensity of 14 mW/cm² at the build plate. The DIW nozzle and UV projector are mounted on two perpendicular Zaber A-LST linear stages with 500 mm of travel that enable both systems to be translated freely about the 120×120 mm build plate. The projector is mounted so that the UV irradiation is projected adjacent to the DIW nozzle. To expose the deposited material to UV irradiation, the printer must move slightly horizontally. Separation of the extrusion and curing step prevents nozzle clogging and allows the amount of UV irradiation the deposited material receives to be precisely controlled. A Zaber A-LST linear slide with 250 mm of travel provides translation in the Z-direction. Standard GCode is used to control the movement of the printer as well as starting and stopping extrusion.

UV-DIW printing process: Parts were printed from the 40 wt. % PAAAE solution in NMP containing 2.5 wt. % TPO with a 25 gauge (0.25 mm) tapered nozzle from Nordson EFD and a layer height of 0.15 mm. A pressure of 0.32 MPa was applied to start extrusion and the nozzle was translated at 4 mm/s. Each layer was exposed to UV irradiation for two seconds after the material was deposited. It was experimentally found that 2 s of exposure was enough to cure the material to a sufficient modulus that enabled post-print handling while preventing over-curing.

Post-processing of additive manufactured PAAAE organo-gels: Parts produced using UV-DIW were placed on a perforated stage in a fume hood and allowed to dry over 2 days. The partially dried gels were then placed on a perforated metal stage, and heated in a vacuum oven (45 mmHg) to 25° C., 60° C., 100° C. and 150° C., for 1 h each. The samples were then transferred into a glass vacuum chamber in a bismuth/tin metal bath and heated under vacuum at 240° C. and 300° C. for 1 h.

Results: The organo-gels produced via UV-DIW retained shape during printing, following tuning of exposure times. Vat photopolymerization yielded complex self-supporting structures which retained shape during layer development.

1. A poly(amide imide) (PAI) precursor polymer (P1), comprising recurring units p, q and r according to formula (I): 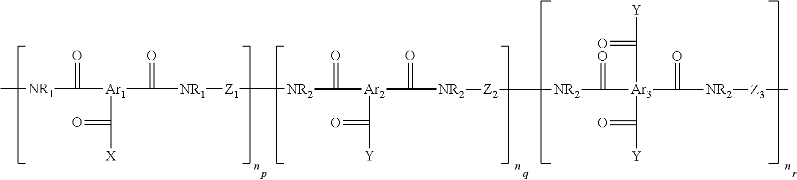
wherein
nₚ, n_{q} and nᵣ are respectively the mole % of each recurring units p, q and r;
recurring units p, q and r are arranged in blocks, in alternation or randomly;
0<nₚ≤100 mol. %;
0<n_{q}≤100 mol. %;
nᵣ is ≥0 mol. %;
Ar₁ and Ar₂, independently from each other, are trivalent aromatic moieties selected from the group consisting of substituted or unsubstituted, saturated, unsaturated or aromatic monocyclic and polycyclic groups having 5 to 50 carbon atoms;
Ar₃ is a tetravalent aromatic moiety selected from the group consisting of a substituted or unsubstituted, saturated, unsaturated or aromatic monocyclic and polycyclic group having 5 to 50 carbon atoms;
Z₁, Z₂ and Z₃, independently from each other, are substituted and unsubstituted divalent organic radicals, optionally comprising one or several heteroatoms,
R₁ and R₂, independently from each other, are H or an alkyl;
X is OR₃, Cl, Br, F or I with R₃ being H or an alkyl;
Y is selected from the group consisting of:
O—(CH₂)ₖ—O—CO—CH═CHR₄, with k being from 1 to 20, and R₄ being H or an alkyl;
O—(CH₂)ₚ—Ar—CR₅═CHR₆ or O—(CH₂)ₚ—OAr—CR₅═CHR₆, wherein p is from 0 to 20, Ar comprises one or two aromatic or heteroaromatic rings, R₅ and R₆ are H or an alkyl, a phenyl or a COOR₇ with R₇ being H or an alkyl;
O—(CH₂)_{q}—CH═CHR₈ with q being from 0 to 20, and R₈ being H or an alkyl;
O—(CH₂)ᵣ—O—CH═CHR₉ with r being from 0 to 20 and R₉ being H or an alkyl; 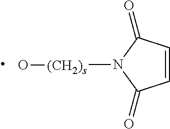
with s being from 0 to 20;
O—, NRₐR_{b}R_{c}H⁺—(CH₂)ₖ—O—CO—CH═CHR₄, with k and R₄ as above-defined;
O—, PRₐR_{b}R_{c}H⁺—(CH₂)ₖ—O—CO—CH═CHR₄, with k and R₄ as above-defined;
O—, NRₐR_{b}R_{c}H⁺—(CH₂)ₚ—Ar—CR₆═CHR₆, with p, Ar, R₅ and R₆ as above-defined;
O—, NRₐR_{b}R_{c}H⁺—(CH₂)ₚ—OAr—CR₆═CHR₆ with p, Ar, R₅ and R₆ as above-defined;
O—, NRₐR_{b}R_{c}H⁺—(CH₂)_{q}—CH═CHR₈, with q and R₈ as above-defined;
O—, NRₐR_{b}R_{c}H⁺—(CH₂)ᵣ—O—CH═CHR₉, with r and R₉ as above-defined; and 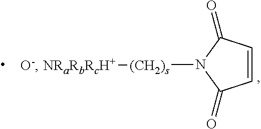
with s as above-defined;
wherein Rₐ, R_{b}, and R_{c} are independently H or an alkyl.

2. The PAI precursor polymer (P1) of claim 1, comprising wherein Ar and Ar₂ are selected from the group consisting of: 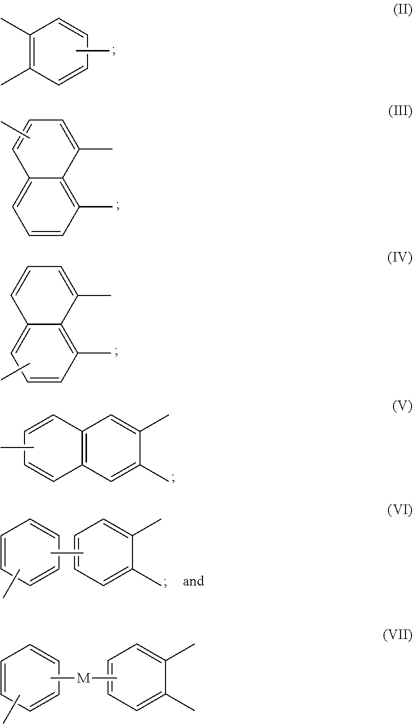
wherein
M is a divalent moiety selected from the group consisting of:
alkylenes having 1 to 6 carbon atoms with n being an integer from 1 to 6;
perfluoroalkylenes having 1 to 6 carbon atoms with n being an integer from 1 to 6;
cycloalkylenes having 4 to 8 carbon atoms;
alkylidenes having 1 to 6 carbon atoms;
cycloalkylidenes having 4 to 8 carbon atoms;
—O—; —S—; —C(O)—; —SO₂—; —SO—; and
a group of the formula —O—Ar₄—O—, with Ar₄ having one or several substituted or unsubstituted, saturated, unsaturated or aromatic monocyclic and polycyclic groups, each group having 5 to 50 carbon atoms.

3. The PAI precursor polymer (P1) of claim 1, wherein the divalent organic radical of Z₁, Z₂ and Z₃ is selected from the group consisting of: 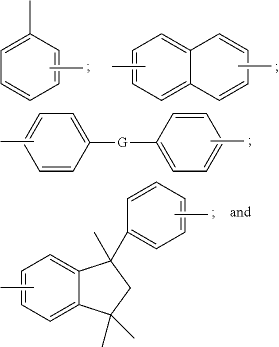
and
wherein
G is selected from the group consisting of:
alkylenes having 1 to 6 carbon atoms with n being an integer from 1 to 6;
perfluoroalkylenes having 1 to 6 carbon atoms with n being an integer from 1 to 6; 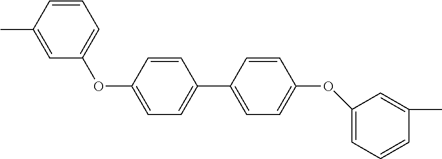
cycloalkylenes having 4 to 8 carbon atoms;
alkylidenes having 1 to 6 carbon atoms;
cycloalkylidenes having 4 to 8 carbon atoms; and
—O—; —S—; —C(O)—; —SO₂—; —SO—.

4. The PAI precursor polymer (P1) of claim 1, wherein at least one of Z₁, Z₂ and Z₃ is according to formula (VIII): 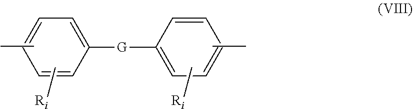
wherein
G is selected from the group consisting of:
alkylenes having 1 to 6 carbon atoms with n being an integer from 1 to 6;
perfluoroalkylenes having 1 to 6 carbon atoms with n being an integer from 1 to 6;
cycloalkylenes having 4 to 8 carbon atoms;
alkylidenes having 1 to 6 carbon atoms;
cycloalkylidenes having 4 to 8 carbon atoms; and
—O—; —S—; —C(O)—; —SO₂—; —SO—; and
R is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium; and
i, for each R, is independently zero or an integer ranging from 1 to 4.

5. The PAI precursor polymer (P1) of claim 1, wherein:
50 mol. %≤(nₚ+n_{q})≤100 mol. %, wherein n_{q}>0 mol. % and nₚ≥0 mol. %.

6. The PAI precursor polymer (P1) of claim 1, wherein the polymer has a number average molecular weight (Mn) (as measured by gel permeation chromatography (GPC) using DMF as a mobile phase, with polystyrene standards) of:
less than 100,000 g/mol; and/or
more than 1,000 g/mol.

7. A formulation (F), comprising:
the PAI precursor polymer (P1) of claim 1; and
at least one solvent;
optionally one photosensitizer;
optionally one photoinitiator;
optionally one blocker.

8. The formulation (F) of claim 7, wherein:
the solvent is selected from the group consisting of chlorobenzene, chloroform, N-methylpyrrolidone (NMP), N,N-dimethylformamide (DMF), N,N-dimethylacetamide (DMAC), 1,3-dimethyl-2-imidazolidinone, tetrahydrofuran (THF), dimethyl sulfoxide (DMSO), sulfolane, water, ethanol, methanol and ammonia;
the photosensitizer is selected from the group consisting of benzophenones, anthraquinone, 9-anthracene methanol and mixtures thereof;
the photoinitiator is selected from the group consisting of 2,2-dimethoxy-2-phenylacetophenone (DMPA), Diphenyl(2,4,6-trimethylbenzoyl)phosphine oxide, phenylbis(2,4,6-trimethylbenzoyl)phosphine oxide and mixtures thereof; and/or
the blocker is selected from the group consisting of avobenzone, 2,5-Bis(5-tert-butyl-benzoxazol-2-yl)thiophene, consisting of: a benzophenone, a benzotriazole, a diazine, a triazine, a benzoate, an oxalanilide, a azobenzone, a metal oxides, and combinations thereof.

9. A process for preparing the PAI precursor polymer (P1) of claim 1, comprising reacting, in the presence of a polar aprotic solvent and an organic base:
a compound of formula (IX): 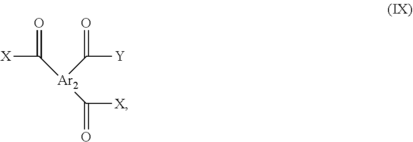
optionally with a compound of any one of formulas (X) and (XI): 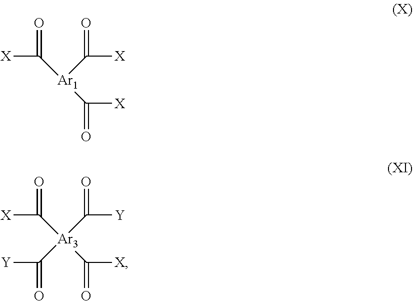
and
a compound of formula (XII):
NRₙRₘ—Z₂—NRₙRₘ (XII)
optionally with a compound of any one of formulas (XIII) or (XIV):
NRₙRₘ—Z₁—NRₙRₘ (XIII)
NRₙRₘ—Z₃—NRₙRₘ (XIV)
wherein:
Ar₁ and Ar₂, independently from each other, are trivalent aromatic moieties selected from the group consisting of substituted or unsubstituted, saturated, unsaturated or aromatic monocyclic and polycyclic groups having 5 to 50 carbon atoms;
Ar₃ is a tetravalent aromatic moiety selected from the group consisting of a substituted or unsubstituted, saturated, unsaturated or aromatic monocyclic and polycyclic group having 5 to 50 carbon atoms;
X is OR, Cl, Br, F or I with R being H or an alkyl;
Rₙ and Rₘ, independently from each other, are H or an alkyl;
Z₁, Z₂ and Z₂, independently from each other, are selected from the group consisting of substituted and unsubstituted divalent organic radicals, optionally comprising one or several heteroatoms,
Y is selected from the group consisting of:
O—(CH₂)ₖ—O—CO—CH═CHR₄, with k being from 1 to 20, and R₄ being H or an alkyl;
O—(CH₂)ₚ—Ar—CR₅═CHR₆ or O—(CH₂)ₚ—OAr—CR₅═CHR₆, wherein p is from 0 to 20, Ar comprises one or two aromatic or heteroaromatic rings, R₅ and R₆ are H or an alkyl, a phenyl or a COOR₇ with R₇ being H or an alkyl;
O—(CH₂)_{q}—CH═CHR₈ with q being from 0 to 20, and R₈ being H or an alkyl;
O—(CH₂)ᵣ—O—CH═CHR₉ with r being from 0 to 20 and R₉ being H or an alkyl; 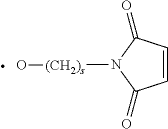
with s being from 0 to 20;
O—, NRₐR_{b}R_{c}H⁺—(CH₂)ₖ—O—CO—CH═CHR₄, with k and R₄ as above-defined;
O—, PRₐR_{b}R_{c}H⁺—(CH₂)ₖ—O—CO—CH═CHR₄, with k and R₄ as above-defined;
O—, NRₐR_{b}R_{c}H⁺—(CH₂)ₚ—Ar—CR₅═CHR₆, with p, Ar, R₅ and R₆ as above-defined;
O—, NRₐR_{b}R_{c}H⁺—(CH₂)ₚ—OAr—CR₅═CHR₆ with p, Ar, R₅ and R₆ as above-defined;
O—, NRₐR_{b}R_{c}H⁺—(CH₂)_{q}—CH═CHR₈, with q and R₈ as above-defined;
O—, NRₐR_{b}R_{c}H⁺—(CH₂)ᵣ—O—CH═CHR₉, with r and R₉ as above-defined; and 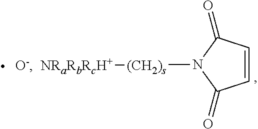
with s as above-defined;
wherein Rₐ, R_{b}, and R_{c} are independently H or an alkyl.

10. A process for preparing the PAI precursor polymer (P1) of claim 1, comprising reacting, in the presence of a polar aprotic solvent and/or an aqueous solvent and/or an alcohol and/or an organic base, or mixtures thereof:
a PAI precursor polymer (PO) of formula RₙRₘN—P—NRₙRₘ, wherein P comprises recurring units p according to formula (XV): 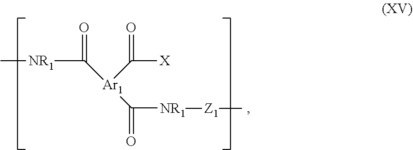
wherein:
Ar₁ is trivalent aromatic moieties selected from the group consisting of substituted or unsubstituted, saturated, unsaturated or aromatic monocyclic and polycyclic groups having 5 to 50 carbon atoms;
X is OR, Cl, Br, F or I with R being H or an alkyl;
Rₙ and Rₘ, independently from each other, are H or an alkyl;
R₁ is H or an alkyl;
Z₁ is a substituted and unsubstituted divalent organic radical, optionally comprising one or several heteroatoms,
with a compound selected from the group consisting of:
NRₐR_{b}R_{c}—(CH₂)ₖ—O—CO—CH═CHR₄, with k and R₄ as above-defined,
PRₐR_{b}R_{c}—(CH₂)ₖ—O—CO—CH═CHR₄, with k and R₄ as above-defined,
NRₐR_{b}R_{c}—(CH₂)ₚ—Ar—CR₅═CHR₆, with p, Ar, R₅ and R₆ as above-defined,
NRₐR_{b}R_{c}—(CH₂)ₚ—OAr—CR₅═CHR₆ with p, Ar, R₅ and R₆ as above-defined,
NRₐR_{b}R_{c}—(CH₂)_{q}—CH═CHR₈, with q and R₈ as above-defined,
NRₐR_{b}R_{c}—(CH₂)ᵣ—O—CH═CHR₉, with r and R₉ as above-defined, and 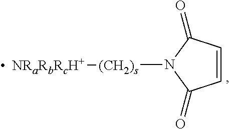
with s as above-defined,
wherein Rₐ, R_{b}, and R_{c} are independently H or an alkyl.

11. A method for manufacturing a three-dimensional (3D) article with an additive manufacturing system, comprising:
providing a formulation (F) according to claim 7,
printing layers of the three-dimensional (3D) article from the formulation (F), and
optionally, curing the 3D article at a temperature ranging from 50 to 450° C.

12. The method of claim 11, wherein the step of printing comprises irradiating the polymer composition with light.

13. Three-dimensional (3D) article or object obtainable, at least in part, by the method of claim 11, comprising recurring units according to formula (XVI), and optionally formula (XVIII): 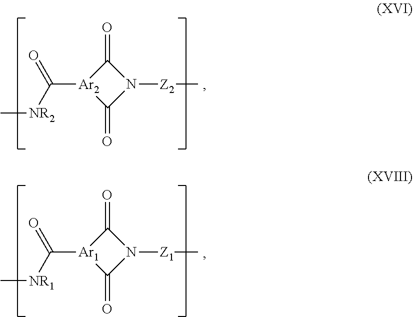
wherein
Ar₁ and Ar₂, independently from each other, are trivalent aromatic moieties selected from the group consisting of substituted or unsubstituted, saturated, unsaturated or aromatic monocyclic and polycyclic groups having 5 to 50 carbon atoms;
R₁ and R₂, independently from each other, are H or an alkyl;
Z₁ and Z₂, independently from each other, are a radical of formula (XIX): 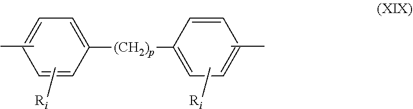
wherein
R is selected from the group consisting of hydrogen, halogen, alkyl, alkenyl, alkynyl, aryl, ether, thioether, carboxylic acid, ester, amide, imide, alkali earth metal sulfonate, alkaline earth metal sulfonate, alkyl sulfonate, alkali earth metal phosphonate, alkaline earth metal phosphonate, alkyl phosphonate, amine and quaternary ammonium, and
i, for each R, is independently zero or an integer ranging from 1 to 4.

14. A method for the manufacture of 3D objects, the method comprising: printing 3D objects comprising the PAI precursor polymer (P1) of claim 1, where the polymer (P1) is printed alone or in a formulation with at least one solvent, optionally one photosensitizer, optionally one photoinitiator, and optionally one blocker, alone or in combination with other components, by vat-photopolymerization, stereolithography (SLA), direct ink writing (DIW), digital light processing (DLP), or inkjet process.

15. A method of coating an article, the method comprising: coating an article with the PAI precursor polymer (P1) of claim 1, optionally in a formulation with at least one solvent, optionally, one photosensitizer, optionally one photoinitiator, and optionally one blocker alone or in combination with other components.
